(19) United States
(12) Patent Application Publication
(10) Pub. No.: US 2026/0065051 A1
(43) Pub. Date: Mar. 5, 2026

(54) METHOD, APPARATUS, DEVICE AND STORAGE MEDIUM FOR TRAINING AN IMAGE GENERATION MODEL

(71) Applicant: Lemon Inc., Grand Cayman (KY)

(72) Inventors: Zhongcong Xu, Singapore (SG); Chaoyue Song, Singapore (SG); Guoxian Song, Los Angeles, CA (US); Jianfeng Zhang, Singapore (SG); Jun Hao Liew, Singapore (SG); Hongyi Xu, Los Angeles, CA (US); You Xie, Los Angeles, CA (US); Linjie Luo, Los Angeles, CA (US); Jiashi Feng, Singapore (SG)

(21) Appl. No.: 19/314,214

(22) Filed: Aug. 29, 2025

(30) Foreign Application Priority Data
Aug. 30, 2024 (CN) 202411215151.9

(51) Int. Cl. G06N 3/08; G06T 11/00; G06V 10/25

(52) U.S. Cl. CPC G06N 3/08; G06T 11/00; G06V 10/25

(57) ABSTRACT

According to an embodiment of the disclosure, a method, apparatus, device and storage medium for training an image generation model is provided. The method includes: obtaining a reference image and a target image; providing, to an image generation model, the reference image and pose information corresponding to the target image to generate an intermediate image, the pose information describing a pose of a target object in the target image; determining a first region in the intermediate image corresponding to a predetermined part of the target object; and training the image generation model based at least on a difference between the first region and a second region in the target image corresponding to the predetermined part.

### CROSS-REFERENCE

This application claims the priority to Chinese Patent Application No. 202411215151.9, entitled “METHOD, APPARATUS, DEVICE AND STORAGE MEDIUM FOR TRAINING AN IMAGE GENERATION MODEL” filed on Aug. 30, 2024, the entire contents of which are incorporated herein by reference.

### FIELD

Example embodiments of the present disclosure generally relate to the field of computers, and in particular, to a method, apparatus, device and computer-readable storage medium for training an image generation model.

### BACKGROUND

With the development of computer technology, animation generation is a key research direction, which combines multiple sub-fields such as computer vision, deep learning, image processing and pattern recognition. With the rapid development of video diffusion models, it has become possible to generate dynamic images with highly realistic and controllability. These technologies exhibit a wide application prospect in many fields such as entertainment industry, movie production, virtual reality, and augmented reality.

### SUMMARY

In a first aspect of the present disclosure, a method for training an image generation model is provided. The method comprises: obtaining a reference image and a target image; providing, to an image generation model, the reference image and pose information corresponding to the target image to generate an intermediate image, the pose information describing a pose of a target object in the target image; determining a first region in the intermediate image corresponding to a predetermined part of the target object; and training the image generation model based at least on a difference between the first region and a second region in the target image corresponding to the predetermined part.

In a second aspect of the present disclosure, a method for generating an image is provided. The method comprises: providing an input image and target pose information to an image generation model; and obtaining an output image generated by the image generation model, a pose of a predetermined object in the output image corresponding to the target pose information, wherein the image generation model is trained based on region difference information, the region difference information indicates a difference between a first region of an intermediate image and a second region in a target image, the first region and the second region correspond to a predetermined part of a target object, the intermediate image is generated by the image generation model based on a reference image and pose information corresponding to the target image, and the pose information describes a pose of the target object in the target image.

In a third aspect of the present disclosure, an apparatus for training an image generation model is provided. The apparatus comprises: a obtaining module configured to obtain a reference image and a target image; a providing module configured to provide, to an image generation model, the reference image and pose information corresponding to the target image to generate an intermediate image, the pose information describing a pose of a target object in the target image; a determination module configured to determine a first region in the intermediate image corresponding to a predetermined part of the target object; and a training module configured to train the image generation model based at least on a difference between the first region and a second region in the target image corresponding to the predetermined part.

In a fourth aspect of the present disclosure, an apparatus for generating an image is provided. The apparatus comprises: an input module configured to provide an input image and target pose information to an image generation model; and a generation module configured to obtain an output image generated by the image generation model, a pose of a predetermined object in the output image corresponding to the target pose information, wherein the image generation model is trained based on region difference information, the region difference information indicates a difference between a first region of an intermediate image and a second region in a target image, the first region and the second region correspond to a predetermined part of a target object, the intermediate image is generated by the image generation model based on a reference image and pose information corresponding to the target image, and the pose information describes a pose of the target object in the target image.

In a fifth aspect of the present disclosure, an electronic device is provided. The device comprises at least one processor; and at least one memory coupled to the at least one processor and storing instructions for execution by the at least one processor. The instructions, when executed by the at least one processor, cause the device to perform the method of the first aspect or the second aspect.

In a sixth aspect of the present disclosure, a computer-readable storage medium is provided. The computer-readable storage medium stores a computer program, and the computer program is executable by the processor to implement the method of the first aspect or the second aspect.

It should be understood that the content described in this content section is not intended to limit the key features or important features of the embodiments of the present disclosure, nor is it intended to limit the scope of the present disclosure. Other features of the present disclosure will become readily understood from the following description.

### BRIEF DESCRIPTION OF DRAWINGS

The above and other features, advantages, and aspects of various embodiments of the present disclosure will become more apparent from the following detailed description in connection with the accompanying drawings. In the drawings, the same or similar reference numbers refer to the same or similar elements, wherein:

FIG. 1 illustrates an example image generation model according to some embodiments of the present disclosure;

FIG. 2 shows a flowchart of an example process for training an image generation model according to some embodiments of the present disclosure;

FIG. 3 illustrates an example training architecture according to some embodiments of the present disclosure;

FIG. 4 shows a block diagram of an apparatus for training an image generation model according to some embodiments of the present disclosure; and

FIG. 5 illustrates a block diagram of an electronic device capable of implementing various embodiments of the present disclosure.

### DETAILED DESCRIPTION

It can be understood that, before the technical solutions disclosed in the embodiments of the present disclosure are used, the types, the usage scope, the usage scenario and the like of personal information related to the present disclosure, should be notified to the user in an appropriate manner according to the relevant laws and regulations and obtain the authorization of the user.

For example, in response to receiving an active request from a user, prompt information is sent to the user to explicitly prompt the user that the requested operation will need to acquire and use the personal information of the user. Therefore, the user can autonomously select whether to provide personal information to software or hardware such as electronic device, application, server or storage medium and the like executing the operation of the technical solution of the present disclosure according to the prompt information.

As an optional but non-limiting implementation, in response to receiving the active request of the user, the manner of sending the prompt information to the user may be, for example, a pop-up window, and the pop-up window may present the prompt information in a text manner. In addition, the pop-up window may further carry a selection control for the user to select “agree” or “not agree” to provide personal information to the electronic device.

It may be understood that the foregoing notification and obtaining a user authorization process is merely illustrative, and does not constitute a limitation on implementations of the present disclosure, and other manners of meeting related laws and regulations may also be applied to implementations of the present disclosure.

It may be understood that the data involved in the technical solution (including but not limited to the data itself, the acquisition or use of the data) should follow the requirements of the corresponding laws and regulations and related regulations.

The term “in response to” as used herein means a state in which a respective event occurs or condition is satisfied. It will be appreciated that the timing of execution of a subsequent action performed in response to the event or condition is not necessarily strongly correlated with the time at which the event occurs or the condition holds. For example, in some cases, subsequent actions may be performed immediately when an event occurs or a condition holds; while in other cases, subsequent actions may be performed after a period of time elapses after an event occurs or a condition holds.

Embodiments of the present disclosure will be described in more detail below with reference to the accompanying drawings. While certain embodiments of the present disclosure are shown in the accompanying drawings, it should be understood that the present disclosure may be implemented in various forms, and should not be construed as limited to the embodiments set forth herein, but rather, these embodiments are provided for a more thorough and complete understanding of the present disclosure. It should be understood that the drawings and embodiments of the present disclosure are for exemplary purposes only and are not intended to limit the scope of the present disclosure.

It should be noted that the title of any section/subsection provided herein is not limiting. Various embodiments are described throughout and any type of embodiments may be included in any section/subsection. Furthermore, the embodiments described in any section/subsection may be combined in any manner with the same section/subsection and/or any other embodiment described in different sections/subsections.

In the description of the embodiments of the present disclosure, the terms “comprising” and the like should be understood to include “including but not limited to”. The term “based on” should be understood as “based at least in part on”. The terms “one embodiment” or “the embodiment” should be understood as “at least one embodiment”. The term “some embodiments” should be understood as “at least some embodiments”. Other explicit and implicit definitions may also be included below. The terms “first,” “second,” and the like may refer to different or identical objects. Other explicit and implicit definitions may also be included below.

While existing studies have made certain advances in image animation generation through generative adversarial networks (GANs) and diffusion-based approaches, these approaches still have limitations in ensuring the authenticity of local detail quality and motion blur of animation results.

In particular, conventional solutions typically employ mean square error (MSE) of the whole body image as a learning objective, which, while effective, is not sufficient to ensure the appearance quality of these smaller regions of the face and hand. In addition, due to limitations of fast motion and capture devices, motion blur is quite common in human centric video, but existing work does not explicitly account for this factor, resulting in unconditional synthetic motion blur, affecting the realism of animation.

To this end, embodiments of the present disclosure provide a solution for training an image generation model. According to various embodiments of the present disclosure, a reference image and a target image may be obtained. Further, the reference image and the pose information corresponding to the target image may be provided to the image generation model to generate an intermediate image, and the pose information describes a pose of the target object in the target image.

Correspondingly, a first region in the intermediate image corresponding to a predetermined part of the target object may be determined. Further, the image generation model may be trained based on at least a difference between the first region and a second region in the target image corresponding to the predetermined part.

Therefore, by applying an additional loss function in these specific regions (for example, the predetermined part of the target object), embodiments of the present disclosure can focus on optimizing the features of these regions, thereby improving the accuracy and definition of the generated image. In addition, the embodiment of the present disclosure can maintain the consistency of the target object in the generated image and improve the realism of the generated image.

Example embodiments of the present disclosure are described below with reference to the accompanying drawings.

### Example System

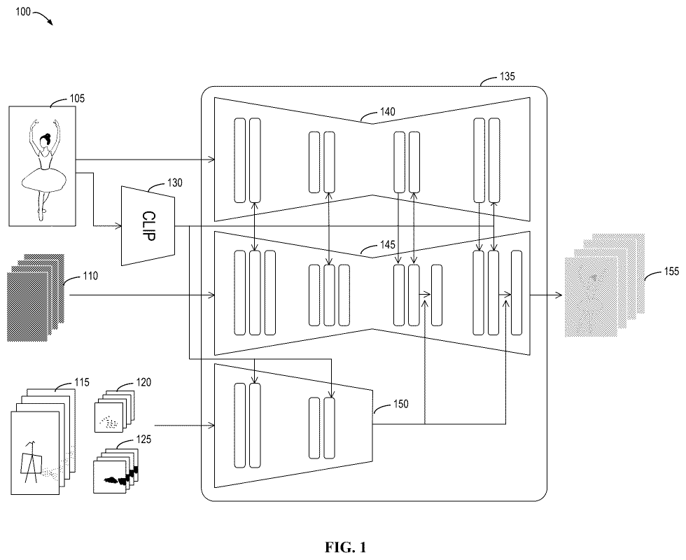

FIG. 1 illustrates an example structure of an example image generation model according to some embodiments of the present disclosure.

As shown in FIG. 1, the image generation model 135 may comprise a combination of a plurality of models or units. For example, the image generation model 135 may comprise an appearance encoder 140, a UNet 145, and a ControlNet 150.

As shown in FIG. 1, an input image 105 may be provided to the appearance encoder 140 to generate a corresponding visual feature. In addition, the input image 105 may also be provided to a Contrastive Lange-Image Pre-training (CLIP) unit 130 to generate a text description corresponding to the input image 105. As shown, such text description may also be provided to the UNet 145.

In addition, the image generation model 135 may also obtain the initial noise 110 to perform the denoising process. Further, the image generation model 135 may also obtain one or more control signals.

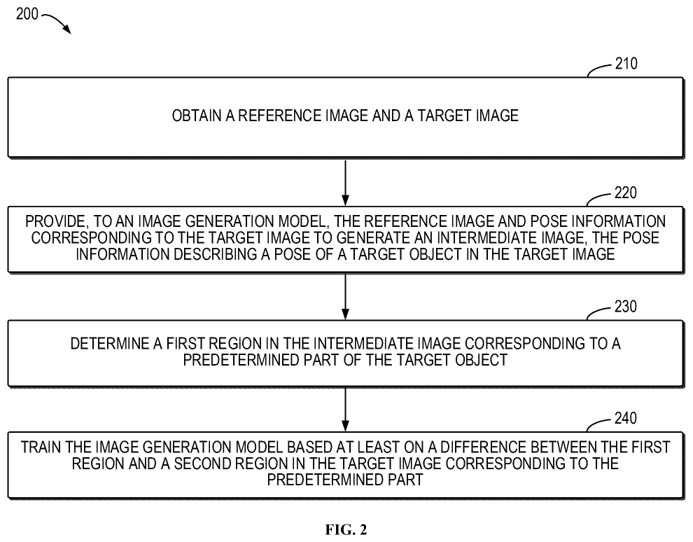

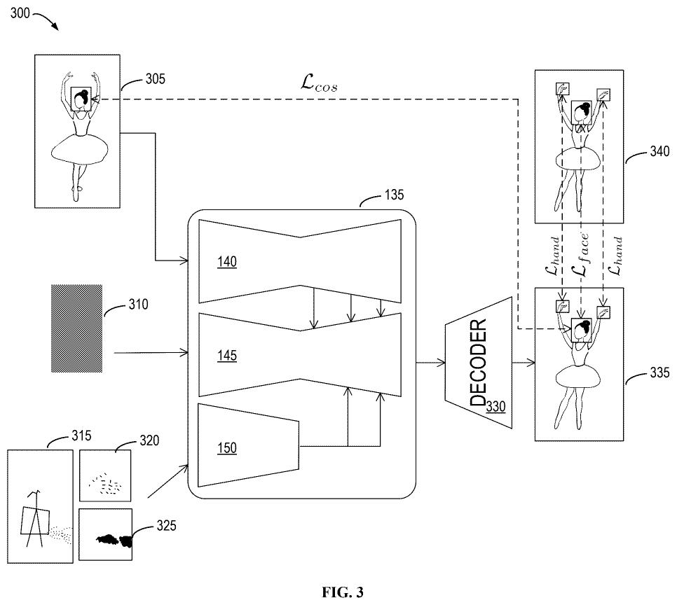

As an example, such control signals may comprise pose information 115, motion information 120, and sharpness information 125. Specific details of the control signal will be described below with reference to FIGS. 2 and 3.

As shown in the figure, control signals may be provided to the ControlNet 150 as control signals for the generation process.

Accordingly, the image generation model 135 may generate the decoded image encoding 155 based on the obtained input information. By decoding the image encoding 155 by using the decoder, an image corresponding to the pose information 115 may be obtained.

As an example, such an image generation model 135 may be used to generate a set of motion consecutive images to generate an image animation, e.g., dance animation, or the like.

A specific training process of the image generation model 135 will be further described below with reference to FIG. 2.

### Example Processes

FIG. 2 illustrates a flowchart of an example process 200 of training an image generation model according to some embodiments of the present disclosure. Process 200 may be implemented at a training system. The process 200 is described below with reference to FIG. 1.

As shown in FIG. 2, at block 210, the training system obtains a reference image and a target image.

In some embodiments, the training system may, for example, obtain video content associated with a target object (e.g., a dancer).

Further, the training system may extract two video frames from the video content as the reference image and the target image respectively. As an example, the image frame corresponding to the starting action of the dancer in the video content may be used as the reference image, and the image frame corresponding to the dance action may be used as the target image.

FIG. 3 illustrates an example process of training an image generation model according to some embodiments of the present disclosure. As shown in FIG. 3, the training system may obtain the reference image 305 and the target image 340 for training the image generation model 135.

At block 220, the training system provides, to an image generation model, the reference image and pose information corresponding to the target image to generate an intermediate image, the pose information describes a pose of a target object in the target image.

With continued reference to FIG. 3, the training system may provide the reference image 305, the noise data 310, and the control signal to the image generation model 135. In some embodiments, the control signal may comprise pose information associated with the target image 340.

As an example, the pose information may describe a pose of a target object (for example, a dancer) in the target image 340. In some embodiments, such pose information may be characterized by a plurality of key points of a target object (e.g., dancer).

In some examples, taking a dance scenario as an example, the hand action of the dancer moves typically faster, which may cause the motion blur issue. To improve the quality of the trained image generation model, the control signal may also comprise motion information 320, which may indicate a motion vector associated with a predetermined part of the target object (e.g., dancer).

As an example, considering the situation that the hand region is more prone to motion blur, the motion information 320 may comprise motion vectors associated with a set of key points of the hand region:

$$v = {p}_{h}^{i} - {p}_{h}^{i - 1} \qquad ( 1 )$$

where v represents a motion vector, pₕ represents a set of key points of the hand, and i represents a time of the corresponding video frame.

In some embodiments, the control signal may also comprise sharpness information 325. The sharpness information 325 may, for example, be used to indicate sharpness information of a predetermined part (for example, a hand) of a target object (for example, a dancer) in the target image 340.

As an example, the Laplace operator may be calculated first:

$$Laplace ( \text{?} ) = \frac{{\partial }^{2} \text{?}}{\partial {x}^{2}} + \frac{{\partial }^{2} \text{?}}{\partial {y}^{2}} \qquad ( 2 )$$

$$\text{?} \text{indicates text missing or illegible when filed}$$

where Iₕ represents the hand images in the target image 340, x and y represent rows and columns of image pixels, respectively. Further, the sharpness score (i.e., sharpness information) may be obtained by calculating the variance of the result of the Laplacian operator. The higher the sharpness score, the clearer the hand region of the image, the more obvious the edge and detail; the lower the sharpness score, the more blurry the hand region.

With continued reference to FIG. 3, the image generation model 135 may decode the noise based on the received input information to generate a corresponding image encoding. Further, the decoder 330 may decode the generated image encoding to generate the intermediate image 335.

With continued reference to FIG. 2, at block 230, the training system determines a first region in the intermediate image corresponding to a predetermined part of the target object.

In some embodiments, in order to improve the stability of the animation content generated by the image generation model, the training system may extract an area corresponding to a predetermined part of the target object (for example, a dancer) from the intermediate image 335.

In some embodiments, such a predetermined part may comprise a face, and the training system 335 may determine a face region in the intermediate image 335. Alternatively or additionally, such a predetermined part may comprise a hand, and the training system 335 may determine a hand region in the intermediate image 335.

In block 240, the training system trains the image generation model based at least on a difference between the first region and a second region in the target image corresponding to the predetermined part.

As shown in FIG. 3, the training system may determine a corresponding training loss based on the region difference. As an example, in a case where the predetermined part comprises a face, the training system may determine a first loss [symbol] _{face} associated with the face.

In some embodiments, the training system may determine the first loss based on the following formula:

$${ℒ}_{face} = \frac{\sum {‖ ( {I}_{tgt} - {I}_{pre} ) ⊙ {M}_{face} ‖}_{2}^{2}}{\sum {M}_{face}} \qquad ( 3 )$$

where, the I_{tgt} represents the target image 340, Iₚᵣₑ represents an intermediate image 335, M_{face} represents a mask of the face. Thus, the training system may determine the first loss based on a difference between a set of pixels of the face region in the target image 340 and a set of pixels of the face region of the intermediate image.

Similarly, in a situation where the predetermined part comprises a hand, the training system may determine a second loss [symbol] _{hand} associated with the hand.

In some embodiments, the training system may determine the second loss based on the following formula:

$${ℒ}_{hand} = \frac{\sum {‖ ( {I}_{tgt} - {I}_{pre} ) ⊙ {M}_{hand} ‖}_{2}^{2}}{\sum {M}_{hand}} \qquad ( 4 )$$

where, the I_{tgt} represents the target image 340, Iₚᵣₑ represents an intermediate image 335, M_{hand} represents a mask of the hand. Thus, the training system may determine the second loss based on a difference between a set of pixels of the hand region in the target image 340 and a set of pixels of the hand region of the intermediate image.

Thus, the target loss associated with the predetermined part (face and/or hand) may comprise a first loss [symbol] _{face} and/or a second loss [symbol] _{hand}.

In some embodiments, to ensure continuity between the generated intermediate image 335 and the reference image 305, the training system may further determine a third region corresponding to a predetermined part (for example, a face) in the reference image 305.

Further, the training system may determine a similarity between the first region and the third region based on the first feature representation of the first region and the second feature representation of the third region, and determine the loss [symbol] _{cos} based on the similarity.

As an example, the training system may determine the loss [symbol] _{cos} based on the following formula:

$${ℒ}_{cos} = 1 - \frac{{ψ}_{ref} \cdot {ψ}_{pre}}{‖ {ψ}_{ref} ‖ ‖ {ψ}_{pre} ‖} \qquad ( 5 )$$

where, ψ_{ref} represents the feature representation of the face region in the reference image 305, ψₚᵣₑ represents the feature representation of the face region in the intermediate image 335.

Based on the processes described above, by applying additional loss functions at these specific regions (e.g., predetermined parts of the target object), embodiments of the present disclosure can be more focused on optimizing the features of these regions, thereby improving the accuracy and definition of the generated images. In addition, the embodiment of the present disclosure can maintain the consistency of the target object in the generated image and improve the realism of the generated image.

In some embodiments, when training the image generation model 135 based on regional supervision, the training system may fix the model parameters of the UNet 145 and the ControlNet 150, and only adjust the model parameters of the appearance encoder 140.

Additionally, the training system may perform a multi-stage training process. Specifically, the training system may train the image generation model 135 based on conventional diffusion losses and adjust model parameters of the appearance encoder 140, the UNet 145, and the ControlNet 150.

Further, the training system may perform an a fine-tuning process based on the regional supervision. During the fine-tuning process, the training system may adjust the parameters of the appearance encoder 140.

As described in FIG. 1, the image generation model 135 may be based on a diffusion model architecture. In some embodiments, the training system 100 may further perform a training process of the image generation model based on a shift signal-to-noise ratio (shift SNR).

Conventionally, in the process of training a diffusion model, the signal-to-noise ratio linearly related to the time step is usually used to control the generation of noise data. However, it is observed through the experiments that such linearly related signal-to-noise ratios are not suitable for higher resolution image generation tasks.

In high-resolution training, the original noise scheduler may not be able to effectively corrupt and reconstruct the image, resulting in poor quality of the generated image. By adjusting the SNR, the balance of the noise and signal in the generation process of the model can be improved, thereby improving the image quality.

Therefore, in the target time step of the training process of the image generation model 135, the training system may determine the corresponding target signal-to-noise ratio based on the target time step, so that the target signal-to-noise ratio has a non-linear correlation with the target time step. Further, the training system may train, at the target time step, the image generation model based on the target signal-to-noise ratio.

Specifically, the process of determining the noise control coefficient β may refer to the following formulas (6) to (10):

$${β}_{t} = 0.00085 \times ( 1 - \frac{t - 1}{T - 1} ) + 0.012 \times \frac{t - 1}{T - 1} \qquad ( 6 )$$

$${α}_{t} = 1 - {β}_{t} \qquad ( 7 )$$

$$snrt = γ \times \frac{{\sum }_{i = 0}^{t} {α}_{i}}{1 - {\sum }_{i = 0}^{t} {α}_{i}} \qquad ( 8 )$$

$${α}_{ct} = \frac{snrt}{1 + snrt} \qquad ( 9 )$$

$${β}_{t} = 1 - \frac{{α}_{ct}}{{α}_{ct - 1}} \qquad ( 10 )$$

wherein, formula (6) is used for calculating the original β value; formula (7) is used for calculating the original α value; formula (8) calculates the adjusted SNR for each time step t; formula (9) and formula (10) are used for recalculating the β value according to the adjusted SNR.

In some embodiments, the training system may also adopt a progressive training strategy, that is, first adapt to low-resolution sample data for training, and subsequently perform training by using higher-resolution sample data.

In some embodiments, such an image generation model may be provided for an image generation process after training of the image generation model is completed. Specifically, in the inference stage of the image generation model, the image generation model may receive the input image, the noise information, and the control parameter (for example, pose information, motion vector, sharpness information), to generate a corresponding output image. Such pose information may indicate a pose of a predetermined object (e.g., a dancer) in the image expected to be generated.

In some embodiments, the noise information may also be determined by performing a predetermined rounds of a diffusion process on the encoded representation of the input image, thereby improving the quality of the generation result.

Further, the target object (for example, the dancer) in generated output image may correspond to a pose indicated in the pose information.

### Example Apparatus And Device

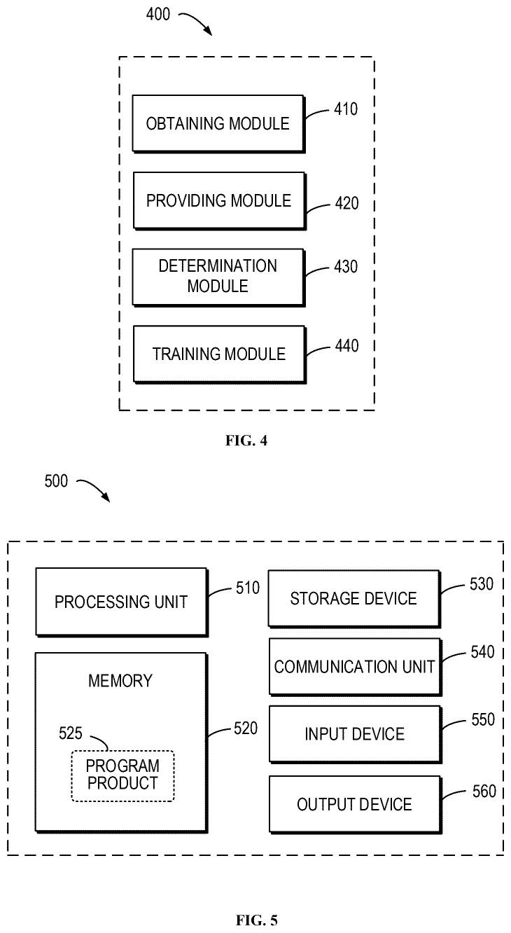

Embodiments of the present disclosure also provide a corresponding apparatus for implementing the above method or process. FIG. 4 is a schematic structural block diagram of an apparatus 400 for training an image generation model according to some embodiments of the present disclosure. The apparatus 400 may be implemented or included in a training system. The various modules/components in the apparatus 400 may be implemented by hardware, software, firmware, or any combination thereof.

As shown in FIG. 4, the apparatus 400 comprises: a obtaining module 410 configured to obtain a reference image and a target image; a providing module 420 configured to provide, to an image generation model, the reference image and pose information corresponding to the target image to generate an intermediate image, the pose information describing a pose of a target object in the target image; a determination module 430 configured to determine a first region in the intermediate image corresponding to a predetermined part of the target object; and a training module 440 configured to train the image generation model based at least on a difference between the first region and a second region in the target image corresponding to the predetermined part.

In some embodiments, the obtaining module 410 is further configured to: obtain video content associated with the target object; and obtain, from the video content, two video frames as the reference image and the target image respectively.

In some embodiments, the training module 440 is further configured to: determine a target loss based on a first set of pixel values of the first region and a second set of pixel values of the second region; and train the image generation model based at least on the target loss.

In some embodiments, the training module 440 is further configured to: determine a third region in the reference image corresponding to the predetermined part; determine a similarity between the first region and the third region based on a first feature representation of the first region and a second feature representation of the third region; and train the image generation model based on the difference and the similarity.

In some embodiments, the predetermined part comprises a face and/or a hand.

In some embodiments, the predetermined part is a first predetermined part, and the providing module 420 is further configured to: provide motion blur information to the image generation model for generating the intermediate image, the motion blur information being associated with a second predetermined part of the target object, and the first predetermined part being same as or different from the second predetermined part.

In some embodiments, the motion blur information indicates: sharpness information of the second predetermined part in the target image; a motion vector associated with the second predetermined part.

In some embodiments, the image generation model is based on a diffusion model, and the training module 440 is further configured to: determine, at a target time step, a target signal-to-noise ratio having a non-linear correlation with the target time step; and train, at the target time step, the image generation model based on the target signal-to-noise ratio.

In some embodiments, the apparatus 400 further comprises an inference module configured to: process an input image with the trained image generation model to generate a corresponding output image.

In some embodiments, the image generation model generates the output image further based on noise information, and the noise information is determined by performing predetermined rounds of a diffusion process on an encoded representation of the input image.

The units included in the apparatus 400 may be implemented in various manners, including software, hardware, firmware, or any combination thereof. In some embodiments, one or more units may be implemented using software and/or firmware, such as machine-executable instructions stored on a storage medium. In addition to or as an alternative to machine-executable instructions, some or all of the elements in the apparatus 400 may be implemented, at least in part, by one or more hardware logic components. By way of example and not limitation, exemplary types of hardware logic components that may be used include field programmable gate arrays (FPGAs), application specific integrated circuits (ASICs), application specific standards (ASSPs), system-on-a-chip (SOCs), complex programmable logic devices (CPLDs), and the like.

FIG. 5 illustrates a block diagram of an electronic device 500 in which one or more embodiments of the present disclosure may be implemented. It should be understood that the electronic device 500 illustrated in FIG. 5 is merely exemplary and should not constitute any limitation on the functionality and scope of the embodiments described herein. The electronic device 500 shown in FIG. 5 may be configured to implement the training system described above.

As shown in FIG. 5, the electronic device 500 is in the form of a general-purpose electronic device. Components of the electronic device 500 may include, but are not limited to, one or more processors or processing units 510, a memory 520, a storage device 530, one or more communication units 540, one or more input devices 550, and one or more output devices 560. The processing unit 510 may be an actual or virtual processor and capable of performing various processes according to programs stored in the memory 520. In multiprocessor systems, multiple processing units execute computer-executable instructions in parallel to improve parallel processing capabilities of electronic device 500.

Electronic device 500 typically includes a plurality of computer storage media. Such media may be any available media accessible to the electronic device 500, including, but not limited to, volatile and non-volatile media, removable and non-removable media. The memory 520 may be volatile memory (e.g., registers, caches, random access memory (RAM)), non-volatile memory (e.g., read-only memory (ROM), electrically erasable programmable read-only memory (EEPROM), flash memory), or some combination thereof. Storage device 530 may be a removable or non-removable medium and may include a machine-readable medium, such as a flash drive, magnetic disk, or any other medium, which may be capable of storing information and/or data and may be accessed within electronic device 500.

The electronic device 500 may further include additional removable/non-removable, volatile/non-volatile storage media. Although not shown in FIG. 5, a disk drive for reading or writing from a removable, nonvolatile magnetic disk (e.g., a “floppy disk”) and an optical disk drive for reading or writing from a removable, nonvolatile optical disk may be provided. In these cases, each drive may be connected to a bus (not shown) by one or more data media interfaces. The memory 520 may include a computer program product 525 having one or more program modules configured to perform various methods or acts of various embodiments of the present disclosure.

The communication unit 540 is configured to communicate with another electronic device through a communication medium. Additionally, the functionality of components of the electronic device 500 may be implemented in a single computing cluster or multiple computing machines capable of communicating over a communication connection. Thus, the electronic device 500 may operate in a networked environment using logical connections with one or more other servers, network personal computers (PCs), or another network node.

The input device 550 may be one or more input devices, such as a mouse, a keyboard, a trackball, or the like. The output device 560 may be one or more output devices, such as a display, a speaker, a printer, or the like. The electronic device 500 may also communicate with one or more external devices (not shown) through the communication unit 540 as needed, external devices such as storage devices, display devices, etc., communicate with one or more devices that enable a user to interact with the electronic device 500, or communicate with any device (e.g., a network card, a modem, etc.) that enables the electronic device 500 to communicate with one or more other electronic devices. Such communication may be performed via an input/output (I/O) interface (not shown).

According to example implementations of the present disclosure, there is provided a computer-readable storage medium having computer-executable instructions stored thereon, wherein the computer-executable instructions are executed by a processor to implement the method described above. According to example implementations of the present disclosure, a computer program product is further provided, the computer program product being tangibly stored on a non-transitory computer-readable medium and including computer-executable instructions, the computer-executable instructions being executed by a processor to implement the method described above.

Aspects of the present disclosure are described herein with reference to flowcharts and/or block diagrams of methods, apparatuses, devices, and computer program products implemented in accordance with the present disclosure. It should be understood that each block of the flowchart and/or block diagram, and combinations of blocks in the flowcharts and/or block diagrams, may be implemented by computer readable program instructions.

These computer-readable program instructions may be provided to a processing unit of a general purpose computer, special purpose computer, or other programmable data processing apparatus to produce a machine, such that the instructions, when executed by a processing unit of a computer or other programmable data processing apparatus, produce means to implement the functions/acts specified in the flowchart and/or block diagram. These computer-readable program instructions may also be stored in a computer-readable storage medium that cause the computer, programmable data processing apparatus, and/or other devices to function in a particular manner, such that the computer-readable medium storing instructions includes an article of manufacture including instructions to implement aspects of the functions/acts specified in the flowchart and/or block diagram(s).

The computer-readable program instructions may be loaded onto a computer, other programmable data processing apparatus, or other devices, such that a series of operational steps are performed on a computer, other programmable data processing apparatus, or other devices to produce a computer-implemented process such that the instructions executed on a computer, other programmable data processing apparatus, or other devices implement the functions/acts specified in the flowchart and/or block diagram block or blocks.

The flowchart and block diagrams in the figures show architecture, functionality, and operation of possible implementations of systems, methods, and computer program products according to various implementations of the present disclosure. In this regard, each block in the flowchart or block diagram may represent a module, program segment, or portion of an instruction that includes one or more executable instructions for implementing the specified logical function. In some alternative implementations, the functions noted in the blocks may also occur in a different order than noted in the figures. For example, two consecutive blocks may actually be performed substantially in parallel, which may sometimes be performed in the reverse order, depending on the functionality involved. It is also noted that each block in the block diagrams and/or flowchart, as well as combinations of blocks in the block diagrams and/or flowchart, may be implemented with a dedicated hardware-based system that performs the specified functions or acts, or may be implemented in a combination of dedicated hardware and computer instructions.

Various implementations of the present disclosure have been described above, which are exemplary, not exhaustive, and are not limited to the implementations disclosed. Many modifications and variations will be apparent to those of ordinary skill in the art without departing from the scope and spirit of the various implementations illustrated. The selection of the terms used herein is intended to best explain the principles of the implementations, practical applications, or improvements to techniques in the marketplace, or to enable others of ordinary skill in the art to understand the various implementations disclosed herein.

1. A method for training an image generation model, comprising:
obtaining a reference image and a target image;
providing, to an image generation model, the reference image and pose information corresponding to the target image to generate an intermediate image, the pose information describing a pose of a target object in the target image;
determining a first region in the intermediate image corresponding to a predetermined part of the target object; and
training the image generation model based at least on a difference between the first region and a second region in the target image corresponding to the predetermined part.

2. The method of claim 1, wherein obtaining the reference image and the target image comprises:
obtaining video content associated with the target object; and
obtaining, from the video content, two video frames as the reference image and the target image respectively.

3. The method of claim 1, wherein training the image generation model based at least on the difference between the first region and the second region in the target image corresponding to the predetermined part comprises:
determining a target loss based on a first set of pixel values of the first region and a second set of pixel values of the second region; and
training the image generation model based at least on the target loss.

4. The method of claim 1, wherein training the image generation model based at least on the difference between the first region and the second region in the target image corresponding to the predetermined part comprises:
determining a third region in the reference image corresponding to the predetermined part;
determining a similarity between the first region and the third region based on a first feature representation of the first region and a second feature representation of the third region; and
training the image generation model based on the difference and the similarity.

5. The method of claim 1, wherein the predetermined part comprises a face and/or a hand.

6. The method of claim 1, wherein the predetermined part is a first predetermined part, and the method further comprises:
providing motion blur information to the image generation model for generating the intermediate image, the motion blur information being associated with a second predetermined part of the target object, and the first predetermined part being same as or different from the second predetermined part.

7. The method of claim 6, wherein the motion blur information indicates:
sharpness information of the second predetermined part in the target image;
a motion vector associated with the second predetermined part.

8. The method of claim 1, wherein the image generation model is based on a diffusion model, and the method further comprises:
determining, at a target time step, a target signal-to-noise ratio having a non-linear correlation with the target time step; and
training, at the target time step, the image generation model based on the target signal-to-noise ratio.

9. The method of claim 1, further comprising:
processing an input image with the trained image generation model to generate a corresponding output image.

10. The method of claim 9, wherein the image generation model generates the output image further based on noise information, and the noise information is determined by performing predetermined rounds of a diffusion process on an encoded representation of the input image.

11. A method for generating an image, comprising:
providing an input image and target pose information to an image generation model; and
obtaining an output image generated by the image generation model, a pose of a predetermined object in the output image corresponding to the target pose information,
wherein the image generation model is trained based on region difference information, the region difference information indicates a difference between a first region of an intermediate image and a second region in a target image, the first region and the second region correspond to a predetermined part of a target object, the intermediate image is generated by the image generation model based on a reference image and pose information corresponding to the target image, and the pose information describes a pose of the target object in the target image.

12. An electronic device, comprising:
at least one processor; and
at least one memory coupled to the at least one processor and storing instructions for execution by the at least one processor, wherein the instructions, when executed by the at least one processor, cause the electronic device to perform acts comprising:
obtaining a reference image and a target image;
providing, to an image generation model, the reference image and pose information corresponding to the target image to generate an intermediate image, the pose information describing a pose of a target object in the target image;
determining a first region in the intermediate image corresponding to a predetermined part of the target object; and
training the image generation model based at least on a difference between the first region and a second region in the target image corresponding to the predetermined part.

13. The electronic device of claim 12, wherein obtaining the reference image and the target image comprises:
obtaining video content associated with the target object; and
obtaining, from the video content, two video frames as the reference image and the target image respectively.

14. The electronic device of claim 12, wherein training the image generation model based at least on the difference between the first region and the second region in the target image corresponding to the predetermined part comprises:
determining a target loss based on a first set of pixel values of the first region and a second set of pixel values of the second region; and
training the image generation model based at least on the target loss.

15. The electronic device of claim 12, wherein training the image generation model based at least on the difference between the first region and the second region in the target image corresponding to the predetermined part comprises:
determining a third region in the reference image corresponding to the predetermined part;
determining a similarity between the first region and the third region based on a first feature representation of the first region and a second feature representation of the third region; and
training the image generation model based on the difference and the similarity.

16. The electronic device of claim 12, wherein the predetermined part comprises a face and/or a hand.

17. The electronic device of claim 12, wherein the predetermined part is a first predetermined part, and the method further comprises:
providing motion blur information to the image generation model for generating the intermediate image, the motion blur information being associated with a second predetermined part of the target object, and the first predetermined part being same as or different from the second predetermined part.

18. The electronic device of claim 17, wherein the motion blur information indicates:
sharpness information of the second predetermined part in the target image;
a motion vector associated with the second predetermined part.

19. The electronic device of claim 12, wherein the image generation model is based on a diffusion model, and the method further comprises:
determining, at a target time step, a target signal-to-noise ratio having a non-linear correlation with the target time step; and
training, at the target time step, the image generation model based on the target signal-to-noise ratio.

20. The electronic device of claim 12, wherein the acts further comprise:
processing an input image with the trained image generation model to generate a corresponding output image.
